(19) United States
(12) Patent Application Publication
(10) Pub. No.: US 2024/0058882 A1
(43) Pub. Date: Feb. 22, 2024

(54) ULTRASONICALLY ASSISTED WIRE ADDITIVE MANUFACTURING PROCESS AND APPARATUS

(71) Applicant: Ohio State Innovation Foundation, Columbus, OH (US)

(72) Inventors: Xun LIU, Columbus, OH (US); Tianzhao WANG, Columbus, OH (US); Ed PFEIFER, Hilliard, OH (US)

(21) Appl. No.: 18/269,818

(22) PCT Filed: Dec. 29, 2021
(86) PCT No.: PCT/US2021/065536

§ 371 Date: Jun. 27, 2023

Related U.S. Application Data
(60) Provisional application No. 63/131,354, filed on Dec. 29, 2020.

(51) Int. Cl. B23K 9/04; B33Y 10/00; B33Y 30/00; B23K 37/06

(52) U.S. Cl. CPC B23K 9/044; B33Y 10/00; B33Y 30/00; B23K 37/06

(57) ABSTRACT

Methods, apparatus and systems for additive manufacturing are provided. Such may include an additive manufacturing material supply, and an energy source that heats the additive manufacturing material supply, forming a melt pool; and an ultrasonic-vibrating member positioned at a distance behind the energy source, such that the ultrasonic-vibrating member is configured to contact the melt pool on a trailing side of the energy source and provide ultrasonic acoustic cavitation and streaming effects to the additive manufacturing process.

### CROSS-REFERENCE TO RELATED APPLICATION

This application claims the benefit of U.S. Provisional Patent Application Ser. No. 63/131,354 entitled “ULTRASONICALLY ASSISTED WIRE ADDITIVE MANUFACTURING PROCESS AND APPARATUS” filed on Dec. 29, 2020. The entirety of the above-noted application is incorporated by reference herein.

### TECHNICAL FIELD

In general, the innovation relates to an ultrasonically assisted wire additive manufacturing (UA-WAM) process, during which a vibrating Ultrasonic probe is immersed in a molten pool of material. More particularly, the innovation provides an advance in additive manufacturing with hybrid techniques especially helpful for producing near net shape large scale metal matrix nanocomposite structures.

### BACKGROUND

In general, additive manufacturing (AM) has grown increasingly popular as a manufacturing technique for a variety of advantages, including its agility to incrementally build complex free-form 3D objects with minimal subtractive machining. Of many different types of AM, wire additive manufacturing (WAM) is one of a direct energy deposition based AM process. WAM may utilize wire as feedstock, and may use as a heat source one or more of several direct energy sources, such as arc, laser or electron beam, and the like. Compared with other AM process, such as powder-based AM processes, WAM advantages may include distinguishably higher deposition rates, energy and material utilization efficiency. For example, with steel processing, arc-based WAM can achieve a 10 kg/h deposition rate compared with the 600 g/h for powder-based process. In further comparison to powder, welding wires are environmentally friendly and are safer to handle. Manufacturing issues associated with powders, such as contamination and oxidation, which may critically degrade 3D printed parts properties, and these types of manufacturing issues may be mitigated effectively, as well as elimination of powder recycling. Several of these characteristics make WAM particularly attractive in building large scale components.

Various forms of direct energy are available with WAM. For example, in arc-based WAM processes, also referred to Wire Arc Additive Manufacturing (WAAM), depending on the nature of the arc source, WAAM can be categorized into gas metal arc welding (GM/kW), gas tungsten arc welding (GTAW), and plasma arc welding (PAW) based processes.

However, and in general, as similar to other AM processes, WAM may share disadvantages such as for example, as-cast microstructure nature drawbacks, including coarse columnar grains, porosities, interdendritic segregation and the lack of strengthening phases. These drawbacks may lead to inferior mechanical properties compared with other traditional manufacturing processes, such as those for wrought products. Disadvantages specific to WAM may also include low geometric accuracy and rough surface finish with layered bulged waviness features, which generally may require some post-machining, which could induce trade-offs between net shape and near net shape manufacturing. In addition, in general WAM processing, there may be concerns of residual stress and distortion, as such may be more severe due in instances of high heat input for some WAM processing.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect, the innovation provides an ultrasonically assisted wire additive manufacturing (UA-WAM) process, during which a vibrating ultrasonic probe is immersed in the molten pool. In an embodiment, the probe may be a longitudinal vibrating ultrasonic probe. In an embodiment, the probe may be placed in the trailing side of the heat source. In an embodiment, the probe may be located about 180° behind the heat source. The ultrasonic acoustic cavitation and streaming effects may help to refine microstructure, reduce porosity and homogenize element distribution.

In one aspect, the innovation provides a system for a UA-WAM process. The system may include an apparatus which includes a UA probe system attached to wire additive manufacturing (WAM) equipment, including but not limited to GMAW-based, CMT-based, GTAW-based, PAW-based, laser-based and electron beam-based WAM.

In an embodiment, the UA probe system may include mounting brackets to secure the UA probe to the WAM equipment, ultrasonic power supply, Ultrasonic transducer, ultrasonic booster, horn, ultrasonic probe, pneumatic cylinder (or linear motor, or the like), and associated control system. It is to be appreciated that embodiments with other mounting arrangements are to be considered within the scope of the disclosed innovation.

In an embodiment, the relative position of the ultrasonic probe and the heat source can be adjusted.

In an embodiment, the ultrasonic probe comprises a refractory metal alloy. In an embodiment, the probe comprises a tungsten alloy. In an embodiment, the probe may be brazed to a screw. The screw contains an aperture having a diameter that substantially matches the ultrasonic probe and is configured such that the aperture may accommodate the ultrasonic probe. The screw may be operatively connected to the ultrasonic horn. In an embodiment, the tungsten alloy probe is brazed to a titanium screw.

### BRIEF DESCRIPTION OF THE DRAWINGS

FIGS. 1A-1B are schematic illustrations of two types of UA-WAM processes.

FIGS. 2A-2B are schematic illustrations of an UA-WAM system according to an embodiment of the innovation.

FIG. 3 provides a multi-view photograph of an embodiment of the innovation.

FIG. 4 provides an example method according to an embodiment of the innovation.

### DETAILED DESCRIPTION

The innovation is now described with reference to the drawings, wherein like reference numerals may not be used to refer to like elements throughout, but are to be understood in the context of the provided discussion. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., materials, thickness, orientation, configuration, etc.), it is to be understood that the features, functions and benefits of the innovation can employ characteristics that vary from those described herein. These alternatives are to be included within the scope of the innovation and claims appended hereto.

Disadvantage noted above in general for general material processing may be even more detrimental when additive material processing is concerned with metal matrix nanocomposite fabrication. Power ultrasound assisted (UA) manufacturing may operate at a number of desired frequencies and power outputs, as would be known to persons skilled in the art as informed by the disclosed innovation, and in an example, may operate at frequencies of 20 kHz or 40 kHz and power outputs of 1-5 kW. Such manufacturing may provide various benefits in processing molten metals, including grain refinement, degassing, and in an embodiment, with improvements in ex situ metal matrix nanocomposite fabrication. These benefits are achieved may be based on two UA induced physical phenomena: high-intensity transient cavitation and acoustic streaming. UA may be referred to variously as ultrasound assisted, ultrasonically assisted, Ultrasound augmented and the like, and it is to be understood the meaning of the term in the context of its use.

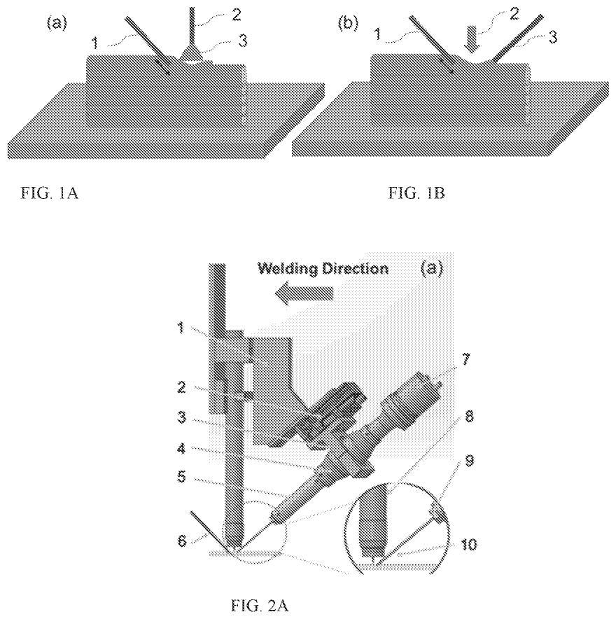

Turning to FIGS. 1A-1B, FIG. 1A depicts gas metal arc welding based WAM process, in which 1: Vibrating ultrasonic probe; 2: Filler metal, which is also the electrode; 3: Arc; and FIG. 1B depicts plasma arc welding-based, as an embodiment, gas tungsten arc welding based, laser based and electron based WAM process, in which: 1: Vibrating ultrasonic probe; 2: Heat input, can be plasma arc, arc, laser or electron bean energy; 3: Filler metal.

It is to be appreciated that various embodiments of the disclosed innovation are possible, and are to be considered within the scope of the disclosed innovation as may be appreciated by a person skilled in the art. In embodiments as illustrated, for example in EEGs. 1A-1B, there are various processes available for WAM. Two of these variants are depicted in FIGS. 1A-1B. FIG. 1A depicts a gas metal arc welding (GMAW) based WAM processes, including its variant of cold metal transfer (CMT) based WAM, In this configuration, the filler metal serves simultaneously as the electrode. In an embodiment according to the innovation, an ultrasonic probe is placed in the trailing side of the arc.

FIG. 1B depicts gas tungsten arc welding (GTAW) based WAM, or plasma arc welding based WAM, or laser WAM or electron beam WAM, depending on the heat source utilized (e.g., arc, laser, or electron beam). In embodiments, a filler metal may be fed in front of the heat input source, and an ultrasonic probe may be placed in the trail of the heat input source.

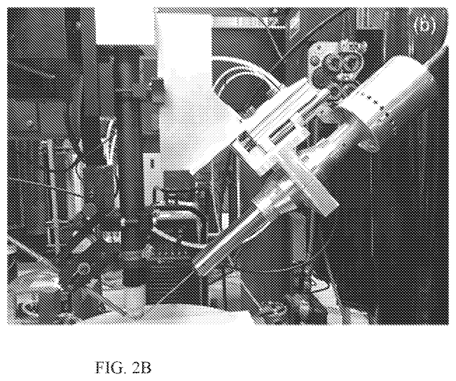

Quickly turning to FIGS. 2A-2B, FIG. 2A illustrates 1: Mounting brackets to install the UA system to the welding machine; 2: Pneumatic cylinder; 3: Mounting brackets for ultrasonic booster; 4: UA booster; 5: Titanium UA horn; 6: Welding wire; 7: UA transducer; 8: Tungsten electrode; 9: Titanium screw; 10: Titanium probe. FIG. 2B illustrates an embodiment according to an aspect of the innovation of a UA-WAM system, notably a photograph of the embodiment presented in FIG. 2A.

FIG. 2A is a schematic illustration of an embodiment of the UA-WAM system according to an aspect of the innovation. The UA-WAM system of FIG. 2A provides an embodiment of an Gas Tungsten Arc Welding (GTAW) based WAM. In this embodiment, as ultrasonic (UA) system may be installed at a trailing side of a non-consumable welding electrode 8, and a filler metal 6 may be fed in front. It is to be appreciated that relative position of the system with regard to the electrode tip 8 may be adjusted through the mounting brackets 1. During a process embodiment, the UA probe 10 may be lowered to a predetermined depth. In an embodiment, the VA probe 10 may be lowered to a prescribed depth (for example, by a pneumatic cylinder 2, a linear motor, or the like) after an arc is stabilized, and may travel together with the electrode to build up layers in a controlled manner.

It is to be appreciated that in embodiments in which an ultrasonic probe is maintained in a molten pool, that the probe may comprise a metal alloy that can withstand the high temperatures in the molten pool. Suitable metal alloys may include, but are not limited to tungsten alloys, aluminum alloys, and steel. In an embodiment, the ultrasonic probe 10 may be made of tungsten alloys.

It is further to be appreciated that finite element analysis may be performed to determine the probe length, in order to, for example, to configure the probe such that at its natural vibration frequency, a longitudinal vibration mode is achieved to resonate with an ultrasonic transducer, such as for example ultrasonic transducer 7 as illustrated in FIG. 2A. In embodiments, a tungsten probe 10 may be brazed with a titanium screw 9. The titanium screw 9 may have a pre-drilled hole, which may match the probe 10 diameter. The titanium screw may be connected to a titanium horn 5, the length of which may be tuned at a half ultrasonic wavelength. The titanium horn 5 may be connected to the ultrasonic booster 4, This booster 4 may be mounted to the machine at the nodal plane with brackets 3 to isolate vibrations from the entire structure.

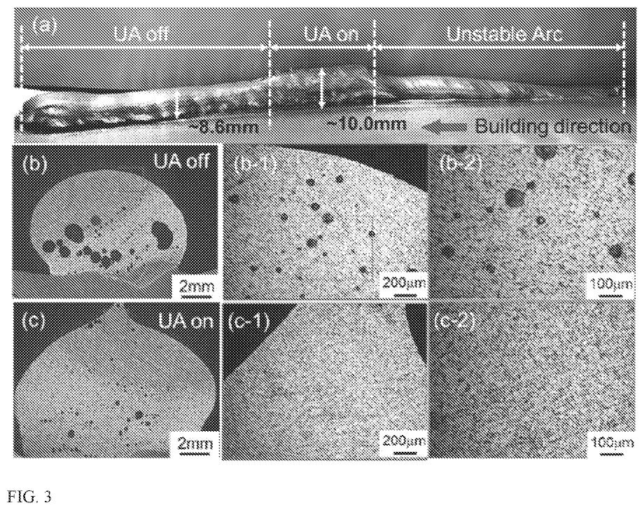

Quickly turning to FIG. 3, Portion (a) of the multi-view photograph portrays an embodiment of a single-bead wall structure, with a Left segment built using a WAM process in contrast with a Right segment under a different WAM process, Portion (b) depicts optical microscopic images showing cross sections of the different WAM built wall at different length scales, Portion (c) depicts optical microscopic images showing cross sections of the UA-WAM built wall of the Left segment at different length scales. The Left segment views provide indications of better material characteristics as described herein. Portion (a) of FIG. 3 shows the single-bead wall structure built with the embodiment of a developed system as shown in FIG. 2B. In this embodiment, the material used for the wall structure was an aluminum alloy AA7075 containing nanoparticles. The wall contained 20 layers. The building direction was from right to left, where UA was applied in the middle section after the arc was stabilized (non-stabilized shown in the Right portion). It is to be appreciated that the figures shown and discussed are for examples of the disclosed innovation, and the principles may be applied in other embodiments, and thus the innovations as disclosed may provide a structure built according to most any appropriate design specification and that amounts and contents of the materials used may be adjusted as would be appreciated by a person of skill in the art with the teachings of this disclosure.

At the left segment, the UA is turned off and conventional. WAM is performed. It was observed that the deposition height of UA-WAAM layers is higher than that in the regular WAM process. Cross sections are compared in FIGS. 3(b) and 3(c). The results show that the amount of porosity is greatly reduced in the UA-WAM segment, which is only around 4.1% compare with the 15.7% in WAM segment from quantitative image analysis. Furthermore, higher magnification views of the cross section, as in FIG. 3 (b-1), (b-2) compared with FIG. 3 (c-1), (c-2), show refined solidification microstructure in UA-WAM compared with regular WAM.

In an aspect of the innovation a method and apparatus for a wire additive manufacturing (WAM) process with superimposed Ultrasonic vibration, which is referred to as ultrasonically assisted WAM (UA-WAAM). The UA energy is in situ applied within a localized molten volume, which it is to be appreciated, may eliminate a requirement of a high ultrasonic power supply in embodiments of applying the method and apparatus for large scale metal components. With such embodiments, for example, dimensions of the built part may not be limited by the output power of the UA transducer.

It is to be further appreciated in that FIGS. 1A-1B, UA induced cavitation and acoustic streaming may enhance active stirring of liquid metal, may fragment dendrites at a solidification front, and may assist in removing dissolved hydrogen in the manufacturing process. Further, back filling from a disturbed liquid metal flow may further restrain porosity and help reduce solidification cracks. The attributes of using ultrasonic assisted WAM may thus help promote a more defect-free and refined solidification structure, which may lead to superior mechanical performance. It is to be appreciated that the disclosed innovation of using ultrasonic energy can provide improvements in at least three aspects: (1) Process: for example, through enlarging processing windows and increasing tolerance for welding wire quality; (2) Microstructure; for example, by decreasing porosity, suppressing solidification cracking, refining structure, and homogenizing element distribution; and an overall (3) Product quality: for example, with enhancing mechanical properties and reducing residual stress and distortion based on the ultrasonically modified thermal history and temperature gradients during the manufacturing process. It is to be appreciated that the Left portion of the portion (c) of FIG. 3 illustrates one or more of these provided improvements.

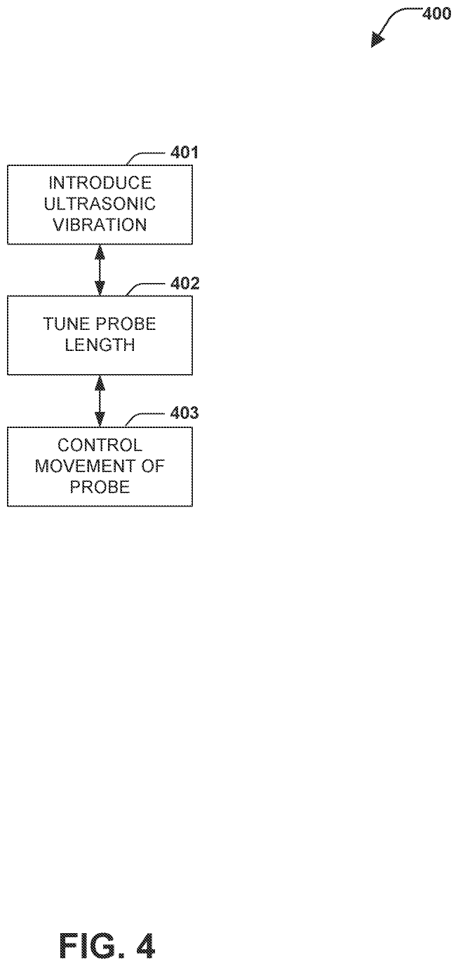

Turning to FIG. 4, in an embodiment 400, an Ultrasonic vibration is introduced 401 into a molten pool through a longitudinal vibrating ultrasonic probe during WAM. The tip of the probe may be inserted or immersed within the molten pool. In an embodiment, the other side of the probe is mechanically connected to an ultrasonic transducer powered by an ultrasonic power supply. At 402, a length of the ultrasonic probe may be tuned such that its natural frequency matches with the ultrasonic excitation frequency (for example, 20 kHz, or for another example, 40 kHz). It is to be appreciated that tuning 402 may occur prior to introducing ultrasonic vibration 401. In one aspect, the innovation may provide an apparatus for UA-WAM. In an embodiment, the ultrasonic probe is attached to the input heat source and traveled together with it during the process, as at 403. It is to be appreciated that control of movement of a heat source may be in tandem with control of the probe, and control of movement may be achieved with 3D multi-degree of freedom motors or robotic arms or the like.

In an embodiment, a control program may be configured to control the movement of components of the UA system. It is to be appreciated that during an additive manufacturing process, position of the probe 10 may be adjusted, including adjusting a distance of probe 10 relative to electrode 8 and/or the depth of the probe into a molten pool.

Control parameters may be pre-determined, and may be varied on application to achieve near net shape with the disclosed improvements. It is to be appreciated that if a distance between probe 10 and electrode 8 is too great, a surface scratch may be left on a top built layer as molten metal may not completely fill in a gap after a pass of the probe (for example, at a relatively lower temperature, as may be enabled in certain embodiments due to lower energy requirements). It is also to be appreciated that if a distance between electrode 8 and the probe 10 is too small, ultrasonic benefits may be diminished and a high arc temperature may damage the probe. Thus, it may be important to maintain control and provide an appropriate position of the probe. In an embodiment, the appropriate position of the probe may be determined by the molten pool geometry, which may be controlled (at least in part) by other the process parameters, which for example may include arc current, voltage, welding speed and filler metal feeding speed.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system for additive manufacturing, comprising:
an additive manufacturing material supply;
an energy source that heats the additive manufacturing material supply,
a melt pool formed by applying heat from the energy source to the additive manufacturing material; and
an ultrasonic-vibrating member positioned at a distance behind the energy source;
wherein said ultrasonic-vibrating member is configured to be immersed within the melt pool on a trailing side of the energy source.

2. The system of claim 1, wherein the additive manufacturing material supply is in the form of a wire.

3. The system of claim 1, wherein the ultrasonic-vibrating member comprises a probe configured to be in tune with an ultrasonic frequency supplied to the probe.

4. The system of claim 3, wherein the ultrasonic-vibrating member comprises a probe comprising one of a high-temperature resistant material, a high temperature metal material, or a high temperature metal alloy material.

5. The system of claim 4, wherein the probe comprises tungsten or a tungsten alloy.

6. The system of claim 3, wherein a length of the probe is tuned for a natural resonating frequency of about 20 kHz.

7. The system of claim 3, wherein a length of the probe is tuned for a natural resonating frequency of about 40 kHz.

8. The system of claim 3, wherein the ultrasonic-vibrating probe is brazed concentrically within a titanium screw.

9. The system of claim 1, wherein the ultrasonic-vibrating member applies ultrasonic-vibrations nonparallel to the additive manufacturing material supply.

10. The system of claim 1, wherein a distance between the energy source and the ultrasonic-vibrating member is varied based on a geometry of the melt pool.

11. An additive manufacturing process comprising:
providing an additive manufacturing material supply;
supplying an energy source to heat the additive manufacturing material supply thereby creating a melt pool; and
applying longitudinal vibrational energy to the melt pool using an ultrasonic-vibrating member.

12. A method of producing a part using additive manufacturing comprising:
depositing an additive manufacturing material supply using a heat source to form a melt pool; and
applying vibrational energy to the melt pool using an ultrasonic-vibrating member;
wherein the ultrasonic-vibrating member is at least partially submerged in the melt pool, and wherein a relative position of an ultrasonic probe of the ultrasonic-vibrating member and heat source can be adjusted.

13. The method of claim 12, wherein the additive manufacturing material supply is deposited using a method of gas metal arc welding.

14. The method of claim 12, wherein the additive manufacturing material supply is deposited using cold metal transfer.

15. The method of claim 12, wherein the additive manufacturing material supply is deposited using gas tungsten arc welding.

16. The method of claim 12, wherein the additive manufacturing material supply is deposited using laser welding.

17. The method of claim 12, wherein the additive manufacturing material supply is deposited using electron beam welding.

18. A device for an additive manufacturing system comprising:
an ultrasonic probe concentrically fitting within a screw connected to a horn;
an ultrasonic booster; and
a power supply.

19. The device of claim 18, wherein a length of the ultrasonic probe is tuned such that its natural frequency matches with an ultrasonic excitation frequency used in the additive manufacturing system.

20. The device of claim 19, wherein the ultrasonic probe vibrates at a frequency between 20 kHz to 40 kHz.
